(19) United States
(12) Patent Application Publication
(10) Pub. No.: US 2015/0329174 A1
(43) Pub. Date: Nov. 19, 2015

(54) ELECTRIC VEHICLE

(71) Applicant: KAWASAKI JUKOGYO KABUSHIKI KAISHA, Kobe-shi, Hyogo (JP)

(72) Inventor: Masafumi Inoue, Miki-shi (JP)

(73) Assignee: KAWASAKI JUKOGYO KABUSHIKI KAISHA, Kobe-shi, Hyogo (JP)

(21) Appl. No.: 14/652,884

(22) PCT Filed: Dec. 25, 2012
(86) PCT No.: PCT/JP2012/008232

§ 371 Date: Jun. 17, 2015

(51) Int. Cl. B62M 7/04; H01M 10/6552; H01M 10/625; H01M 10/6563; H01M 2/10; H01M 10/613

(52) U.S. Cl. CPC B62M 7/04; H01M 2/1077; H01M 10/613; H01M 10/625; H01M 10/6563; H01M 10/6552; H01M 2/1083; H01M 2220/20

(57) ABSTRACT

An electric vehicle comprises an electric motor for generating driving power for driving a wheel; and a battery case accommodating a plurality of batteries storing DC power supplied to the electric motor in an inner battery space; wherein the plurality of batteries are arranged in an interior of the battery case, wherein the battery case includes an inlet through which a cooling medium is introduced into the battery space, and an outlet through which the cooling medium which has cooled the plurality of batteries is discharged outside of the battery space, and a seal member is placed in a predetermined location of a space formed between the plurality of batteries or the batteries and the battery case, the seal member defining a cooling passage in which the cooling medium introduced through the inlet travels in one direction between the batteries toward the outlet.

### TECHNICAL FIELD

The present invention relates to an electric vehicle which drives a wheel with driving power generated in an electric motor.

### BACKGROUND ART

In recent years, an electric vehicle has been developed which drives a wheel with driving power generated in an electric motor using electric power supplied from batteries. Patent Literature 1 discloses an electric motorcycle as an exemplary electric vehicle. In this electric motorcycle, a plurality of batteries are accommodated in a battery box. The battery box includes an air inlet and an air outlet for air used for cooling the batteries. In this electric motorcycle, the air is introduced from outside into the battery box through the air inlet according to an operation of a cooling fan, and guided outside of the battery box through the air outlet.

### CITATION LIST

### Patent Literature

Patent Literature 1: Japanese Laid-Open Patent Application Publication No. 2010-83372

### SUMMARY OF INVENTION

### Technical Problem

In an interior of the battery box, a space (gap) is formed between the batteries, and between the batteries and the box. The air travels through this space. However, in the interior of the battery box, the air may become stagnant, or air flow may be non-uniform, so that the batteries cannot be cooled sufficiently. If the volume of the cooling fan is increased to improve the cooling performance of the batteries, then the configuration will become complex.

Accordingly, an object of the present invention is to improve the cooling performance of a plurality of batteries accommodated in a battery case, with a simple configuration.

### Solution to Problem

The present invention provides an electric vehicle comprising: an electric motor for generating a driving power for driving a wheel; and a battery case accommodating a plurality of batteries storing DC power to be supplied to the electric motor in an inner battery space; wherein the plurality of batteries are arranged in an interior of the battery case, wherein the battery case includes an inlet through which a cooling medium is introduced into the battery space, and an outlet through which the cooling medium which has cooled the plurality of batteries is discharged outside of the battery space, and wherein a seal member is placed in a predetermined location of a space formed between the plurality of batteries or the batteries and the battery case, the seal member defining a cooling passage in which the cooling medium introduced through the inlet travels in one direction through the space toward the outlet.

In accordance with this configuration, the seal member allows the cooling medium guided to a specified cooling passage to flow uniformly and smoothly in the interior of the battery case to cool the plurality of batteries. Therefore, the cooling performance of the batteries can be improved with a simple configuration.

The cooling passage may include: an upstream space which is constituted by a portion of the space and into which the cooling medium from the inlet which has not yet taken heat out of the batteries flows; an intermediate space which is constituted by a portion of the space, which extends continuously from the upstream space, and in which the cooling medium takes heat out of the batteries; and a downstream space which is constituted by a portion of the space, extends continuously from the intermediate space, and guides the cooling medium which has taken heat out of the batteries to the outlet, wherein the seal member is placed in a location to inhibit the cooling medium from directly flowing from the upstream space to the downstream space without flowing through the intermediate space.

In accordance with this configuration, it becomes possible to prevent a situation in which the cooling medium from the inlet travels toward the outlet without taking heat out of the batteries. Therefore, the cooling performance can be improved.

The inlet may be provided on an upper portion of the battery case, and the cooling passage may include a lower space which is placed below at least one of the batteries and into which the cooling medium from the inlet flows.

In accordance with this configuration, the cooling medium with a low temperature from the inlet can be guided to the lower space by utilizing convection. Since the inlet is provided on the upper portion of the battery case, it becomes possible to suppress radiation heat from a road surface from entering the battery space through the inlet. In addition, the component required to introduce the air into the battery case is not placed on the lower portion of the battery case. Therefore, the battery case is allowed to be placed close to the road surface, and thus a center of gravity of the vehicle body can be lowered.

The outlet may be provided on an upper portion of the battery case, and the cooling passage may include a vertical space which is adjacent to the batteries and extends vertically, and a horizontal space connecting the vertical space to the outlet and extending horizontally.

In accordance with this configuration, the cooling medium which has taken heat out of the batteries travels upward through the vertical space, and then is guided to the outlet through the horizontal space. It becomes easier to suppress the cooling medium which has taken heat out of the batteries from travelling into the space between the batteries again. Even when the cooling medium flowing in the interior of the battery case is a small amount, heat accumulation in the interior of the battery space can be prevented.

The outlet may be provided on an upper portion of the battery case.

In accordance with this configuration, it becomes possible to prevent the cooling medium which has taken heat out of the batteries from becoming stagnant in the interior of the battery case.

The electric vehicle may comprise a water removing section which removes water from air outside of a vehicle body; and a fan which guides the air from which the water has been removed by the water removing section to the battery space as the cooling medium.

In accordance with this configuration, the amount of the water which flows into the battery case can be reduced.

### Advantageous Effects of Invention

As should be appreciated from the above, in accordance with the present invention, the cooling performance of a plurality of batteries accommodated in a battery case can be improved with a simple configuration.

### BRIEF DESCRIPTION OF DRAWINGS

FIG. 1 is a left side view of an electric motorcycle according to an embodiment.

FIG. 2 is an exploded perspective view of a power unit (motor unit is not shown) of the electric motorcycle of FIG. 1, when viewed from the left and front.

FIG. 3 is an exploded perspective view of the power unit (motor unit is not shown) of the electric motorcycle of FIG. 1, when viewed from the right and rear.

FIG. 4 is a perspective view of a reinforcement frame of FIGS. 2 and 3.

FIG. 5 is a perspective view of a region above a battery case of the electric motorcycle of FIG. 1, when viewed from the right and front, showing a state in which an inverter and the like are detached from an electric component group.

FIG. 6A is a left side cross-sectional view of the battery case, schematically showing the flow of air for cooling batteries in the electric motorcycle of FIG. 1.

FIG. 6B is a view showing the flow of air for cooling the batteries in the electric motorcycle of FIG. 1.

### DESCRIPTION OF EMBODIMENTS

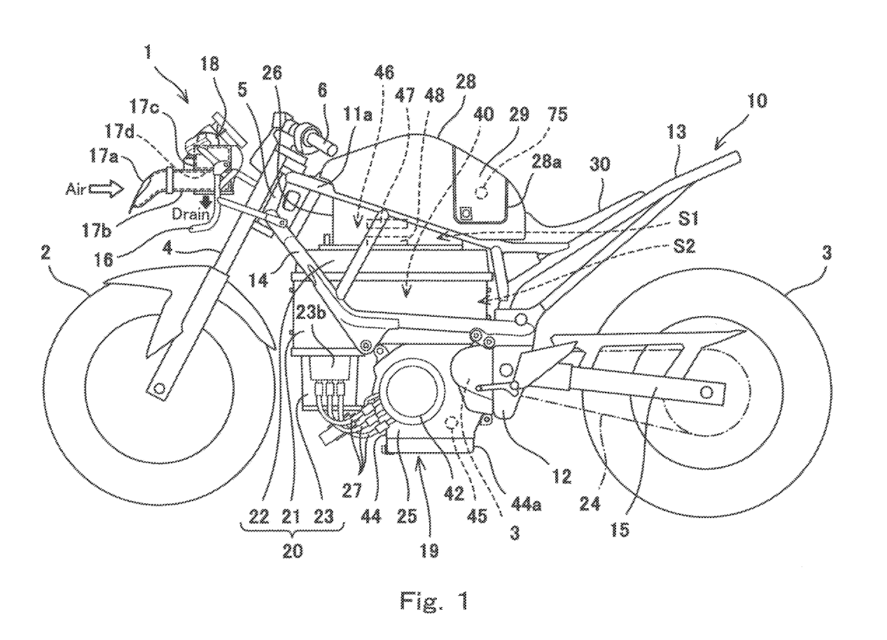

Hereinafter, the embodiment of the present invention will be described with reference to the accompanying drawings. FIG. 1 is a left side view of an electric motorcycle according to an embodiment. As shown in FIG. 1, an electric motorcycle 1 which is a straddle-type vehicle includes a front wheel 2 which is a driven wheel, and a rear wheel 3 which is a drive wheel. The front wheel 2 is rotatably mounted to the lower end portion of a front fork 4. The upper portion of the front fork 4 is integrated with a steering shaft (not shown). The steering shaft is rotatably supported by a head pipe 5 of a vehicle body in a state in which the steering shaft is inserted into the head pipe 5. A handle 6 protruding in a rightward and leftward direction is attached to the steering shaft, and an accelerator grip (not shown) is provided at the right side of the handle 6.

A vehicle body frame 10 includes a pair of right and left main frames 11 extending rearward from the head pipe 5 such that they are inclined slightly downward, and a pair of right and left down frames 14 which extend downward from the head pipe 5, then are bent, and extend rearward in a location below the main frames 11. The rear end portions of the main frames 11 and the rear end portions of the down frames 14 are connected to a pivot frame 12 with a frame shape. The front end portion of a swing arm 15 is mounted to the pivot frame 12 such that the swing arm 15 supports the rear wheel 3 and is vertically pivotable. A rear frame 13 is placed above the swing arm 15. The rear frame 13 extends rearward from the rear end portions of the main frames 11 or the upper portion of the pivot frame 12.

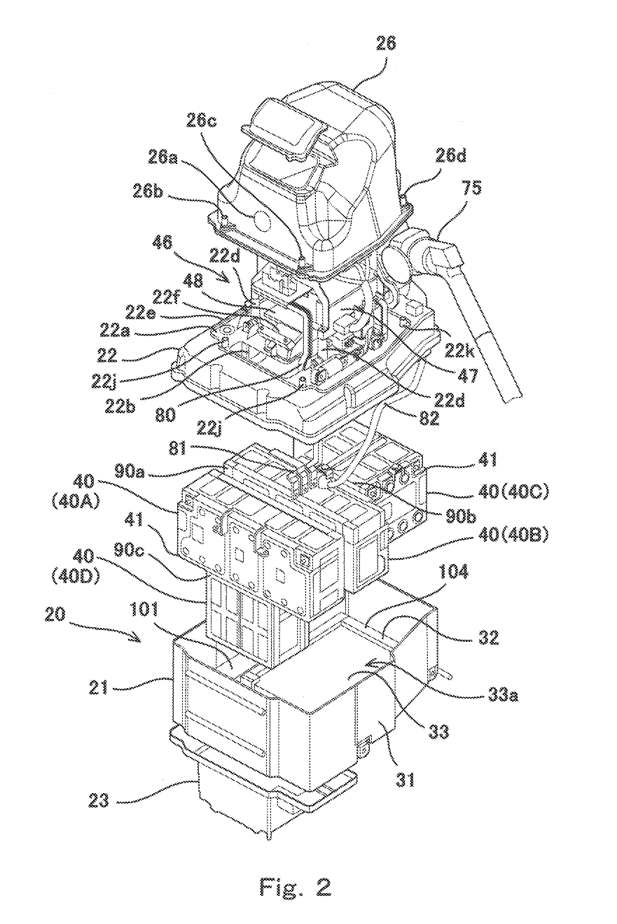

The vehicle body frame 10 supports a power unit 19. The power unit 19 is configured such that a plurality of batteries 40, a motor unit 25 including an electric motor 42, an electric component group 46 including an inverter 47 (see FIG. 2) and a fan 48 (see FIG. 2), etc., are integrated. The plurality of batteries 40 are accommodated into a battery case 20. The battery case 20 includes a middle case 21 which has a tubular shape in which upper and lower sides thereof are opened, and the lower end of a rear section is opened, and a lower case 23 attached to the middle case 21 to close a lower end opening 32c in the front portion of the middle case 21. The case members 21 to 23 are coupled to each other, thereby forming a battery space S2, in which the batteries 40 are accommodated in the interior of the battery case 20.

The motor unit 25 includes a casing 44, an electric motor 42 accommodated in the casing 44 to generate a driving power for moving the vehicle body, with an electric power supplied from the batteries 40, a transmission 43 accommodated in the casing 44 to change the speed of a rotational driving power output from the electric motor 42, an oil pan 44a attached to the lower portion of the casing 44, and an oil pump 45 which suctions up and outputs oil stored in the oil pan 44a. The rotational driving power output from the transmission 43 is transmitted to the rear wheel 3 via a chain 16.

On the upper surface of the battery case 20, an electric component cover 26 is attached to an upper case 22. In the interior of the electric component cover 26, an electric component space S1 in which the electric component group 46 is accommodated is formed. The electric component space S1 is adjacent to the battery space S2 in a vertical direction, with the upper case 22 as a separating wall interposed between the electric component space S1 and the battery space S2. The batteries 40 are connected to the inverter 47 via electric wires 81, 82 (see FIG. 2) penetrating the upper case 22. The electric wires 81, 82 are entirely accommodated in the battery case 20 and the electric component cover 26. The inverter 47 is electrically connected to the electric motor 42 via an electric wire through which a three-phase AC current flows. This electric wire includes a first electric wire member 80 (see FIG. 2) extending through the electric component space S1 and the battery space S2, and a second electric wire member 27 connecting the first electric wire member 80 to the electric motor 42. The two electric wire members are connected to each other via a terminal block 23b provided on the lower case 23. The first electric wire member enters the battery space S2 through the electric component space S1 from above, extends over substantially the entire of the battery space S2 in the vertical direction, and reaches the terminal block 23b. The second electric wire member 27 is composed of three electric cables and externally connects the battery case 20 to the motor unit 25.

The electric component cover 26 is covered by an upper cover 28 which is a dummy tank which looks like a fuel tank of a conventional engine-driven motorcycle. The rear portion of the upper cover 28 is formed with a connector opening 28a through which a charging connector 75 is exposed. The connector opening 28a is closed by a connector lid member 29. The rear portion of the upper cover 28, corresponding to the connector lid member 29, is smaller in dimension in the vehicle width direction than the center portion of upper cover 28, covering the electric component cover 26. A driver seat 30 supported by the rear frame 13 is placed rearward relative to the upper cover 28. The driver seated on a seat 30 can retain the upper cover 28 with both legs. The upper surface of the battery case 20 is located below the upper end of the seat 30. In this configuration, even when the electric component group 46 is placed on the battery case 20, it becomes possible to lessen the amount by which the electric component group 46 protrudes upward from a virtual line connecting the seat 30 to the head pipe 5.

In the present embodiment, the inverter 47 is cooled mainly with the oil stored in the oil pan 44a as the cooling medium (refrigerant), while the batteries 40 are cooled mainly with the air as the cooling medium. In the vehicle body frame 10, a front stay 16 is fastened to the head pipe 5 or a region in the vicinity of the head pipe 5. The front stay 16 protrudes forward farther than the head pipe 5. An air-intake duct 17 is attached to the front stay 16 to take in the air as the cooling medium from outside. In a state in which the assembling of the components of the vehicle body is completed, the air-intake duct 17 is covered laterally and from above, by a cowling (not shown) and a head lamp unit (not shown) which are attached to the front stay 16.

An inlet 17a which is opened to the outside air is provided in the front end portion of the air-intake duct 17, to allow the air (ram air) flowing from in front of the vehicle to be easily introduced into the air-intake duct 17. The rear end portion of the air-intake duct 17 is connected to the front portion of the electric component cover 26. The outside air flows into the air-intake duct 17 through the inlet 17a, and then is guided to the electric component space S1. After that, the air is guided to the battery space S2 adjacent to the electric component space S1, flows through the interior of the battery space S2 accommodating the batteries 40, and flows out of the battery space S2. The air flow in the interior of the battery space S2 will be described later.

The air-intake duct 17 includes a water removing section 18 for removing water contained in the outside air. In the present embodiment, the water removing section 18 separates the water from the air using centrifugal force (centrifugal gas-liquid separation). For example, the air-intake duct 17 includes a lower duct 17b extending rearward from the inlet 17a, and an upper duct 17c placed on the rear end portion of the lower duct 17b and extending rearward farther than the lower duct 17b does. The rear end portion of the lower duct 17b is in communication with the front end portion of the upper duct 17c placed above the lower duct 17b to overlap with the rear end portion of the lower duct 17b, via an inner passage 17d. The inner passage 17d has a vortex or spiral shape. The centrifugal gas-liquid separation is performed while the air is travelling in a circumferential direction and upward along the inner passage 17d. Thus, the water removing section 18 may include the rear end portion of the lower duct 17b, the inner passage 17d of the vortex or spiral shape, and the front end portion of the upper duct 17c.

By the action of the water removing section 18, the air from which the water has been removed is guided as the cooling medium to the electric component space S1 and the battery space S2. Therefore, even when outside air contains water, it becomes possible to inhibit the water from reaching the electric component space S1 and the battery space S2. Since the water removing section 18 of the present embodiment performs the centrifugal gas-liquid separation, maintenance of the water removing section 18 is not necessary, a pressure loss can be reduced, and the structure can be reduced in size, which is an advantage. The lower surface of the rear end portion of the lower duct 17b is always opened, or openable and closable. Therefore, the weight of the separated water makes the water drain outside of the electric motorcycle 1 through the opening.

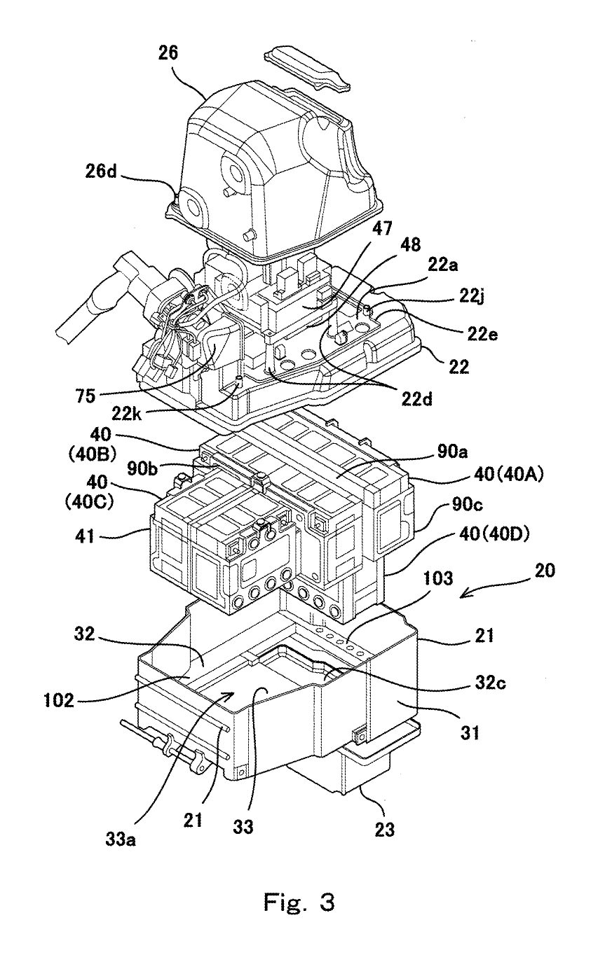

FIG. 2 is an exploded perspective view of the power unit 19 (motor unit 25 is not shown) of the electric motorcycle 1 of FIG. 1, when viewed from the front and the left FIG. 3 is an exploded perspective view of the power unit 19 (motor unit 25 is not shown) of the electric motorcycle 1 of FIG. 1, when viewed from the rear and the right As shown in FIGS. 2 and 3, the plurality of batteries 40 are integrated as an assembly by a casing 41 to form a battery group which is symmetric in the vehicle width direction. Each of the plurality of batteries 40 has a rectangular parallelepiped shape. The plurality of batteries 40 include two kinds of batteries which are different in long side dimensions, when viewed from above. Hereinafter, depending on the case, the batteries with a larger long side dimension will be referred to as “larger batteries”, while the batteries with a smaller long side dimension will be referred to as “smaller batteries”.

The battery group has an inverted-L shape when viewed from a side (in a side view of the vehicle body). The plurality of batteries 40 are aligned in such a manner that the lower surface of the front section of the battery group is located below the lower surface of the rear section of the battery group, the upper surface of the battery group is substantially flat without a level difference, and the front surface of the battery group is substantially flat without a level difference. In other words, the battery group of the plurality of batteries 40 includes the front section composed of upper and lower parts and the rear section which is equal in vertical dimension to the upper part of the front section. This makes it possible to prevent an increase in the dimension of the rear portions of the batteries 40 in the rightward and leftward direction while increasing the capacity of the whole of the batteries 40.

When viewed from the front, the battery group has a T shape (in a front view of the vehicle body) and is symmetric in the vehicle width direction. The plurality of batteries 40 are aligned in such a manner that the upper part of the front section of the battery group has a larger width than the lower part of the front section. In this structure, the upper part of the front section of the battery group is formed with a lateral protruding section protruding to both sides in the vehicle width direction from the perspective of the lower part of the front section. The plurality of batteries 40 are aligned in such a manner that the lower surface of the lateral protruding section is substantially coplanar with the lower surface of the rear section.

When viewed from above, the battery group has a T shape (in a plan view of the vehicle body) and is symmetric in the vehicle width direction. The plurality of batteries 40 are aligned in such a manner that the upper part of the front section of the battery group has a larger width than the rear section. This makes it possible to prevent an increase in the vertical dimension of the whole of the batteries 40 while increasing the capacity of the whole of the batteries 40.

The specific example of the alignment of the plurality of batteries 40 will now be described. In the upper part of the front section, two larger batteries 40A, 40B are arranged in the forward and rearward direction such that their long sides correspond with the rightward and leftward direction. In the rear section, a smaller battery 40C is placed such that its long side corresponds with the forward and rearward direction. In the lower part of the front section, a smaller battery 40D is placed such that its long side corresponds with the rightward and leftward direction. Although the layout in which one battery is included in the vertical direction in each of the upper part of the front section, the lower part of the front section, and the rear section is merely exemplary, a plurality of batteries may be stacked together in the vertical direction in each of the upper part of the front section, the lower part of the front section, and the rear section. Also, the layout in which two batteries are included in the forward and rearward direction in the upper part of the front section and one battery is included in the forward and rearward direction in each of the lower part of the front section and the rear section is merely exemplary. Thus, the number of batteries aligned in the forward and rearward direction in each of the sections may be suitably changed.

The battery group is accommodated into the middle case 21 through the above upper end opening in a state in which the upper case 22 is detached from the middle case 21. The middle case 21 includes a casing body 31 of a rectangular tubular shape, and a reinforcement frame 32 provided on the inner bottom portion of the casing body 31. The reinforcement frame 32 has a rectangular frame shape, and is integrated with the casing body 31 in such a manner that the outer edge portion of the reinforcement frame 32 is welded to the inner surface of the casing body 31 with a rectangular cross-section.

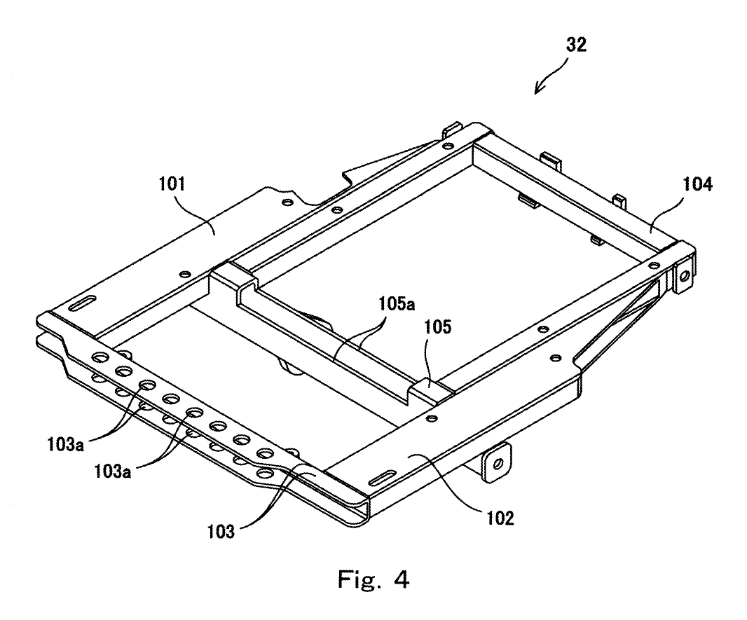

FIG. 4 is a perspective view of the reinforcement frame 32 of FIGS. 2 and 3. The reinforcement frame 32 includes a pair of right and left side members 101, 102, a front member 103 connecting the front end portions of the side members 101, 102 in the rightward and leftward direction, a rear member 104 connecting the rear end portions of the side members 101, 102 in the rightward and leftward direction, and a center cross member 105 placed between the front member 103 and the rear member 104 in the forward and rearward direction and connecting the intermediate end portions of the side members 101, 102 in the rightward and leftward direction. In the interior of the reinforcement frame 32, a rear region and a front region thereof defined by the center cross member 105 are opened, and a rear region thereof is closed by a bottom plate 33 (see FIGS. 2 and 3). The reinforcement frame 32 is welded to the casing body 31 in a state in which the front region is opened.

Turning back to FIGS. 2 and 3, in the state in which the reinforcement frame 32 including the bottom plate 33 is welded to the casing body 31, the opening 32c is formed only in the front region of the lower end of the middle case 21. Also, the upper surfaces of the side members 101, 102, the upper surface of the center cross member 105, and the upper surface of the rear member 104 define the inner bottom surface of a frame shape of the middle case 21.

When the battery group is accommodated into the middle case 21 through the upper end opening, the lower part of the front section is accommodated into the lower case 23 through the above lower end opening 32c. Then, the lower surface of the lateral protruding section of the upper part of the front section, and the lower surface of the rear section which is coplanar with the lower surface of the lateral protruding section are placed on the inner bottom surface of the middle case 21. Since the lateral protruding section is configured such that the lower part of the front section has a smaller width than the upper part of the front section, as described above, the lower part of the front section can pass through the lower end opening 32c surrounded by the reinforcement frame 32 and can be accommodated into the lower case 23, while supporting the batteries 40 of the upper part of the front section with the reinforcement frame 32.

After the battery group has been accommodated into the middle case 21 and the lower case 23 in the above-described manner, the upper case 22 is attached to the middle case 21 in such a way that the upper case 22 closes the upper end opening of the middle case 21 from above. Thereby, the middle case 21, the upper case 22, and the lower case 23 define the battery space S2 which is closed, and the plurality of batteries 40 are aligned and accommodated into the battery space S2.

The lower surface of the upper part of the front section and the lower surface of the rear section are supported on the upper surfaces of the side members 101, 102, and placed at a distance above the upper surface of the bottom plate 33. With reference to FIG. 4, the center cross member 105 has a shape in which its upper portion is cut out. Upper edges 105a of the center cross member 105 are located below the upper surfaces of the side members 101, 102 and the upper surface of the rear member 104. The bottom plate 33 is placed on the upper edges 105a of the center cross member 105 with the upper portion cut out, and welded to the reinforcement frame 32 in a horizontal posture. Because of this, the edge portions of the bottom plate 33 are welded to the inner side surfaces of the side members 101, 102, and the inner side surface of the rear member 104, and therefore, the upper surface of the bottom plate 33 is located below the upper surfaces of the side members 101, 102. In this structure, the reinforcement frame 32 and the bottom plate 33 define a recess 33a with a rectangular cross-section which is surrounded by the inner side surfaces of the side members 101, 102, the inner side surface of the rear member 104, the inner side surface of the center cross member 105, and the inner side surface of the bottom plate 33. In the state in which the batteries 40 are accommodated in the middle case 21, the recess 33a is closed by the lower surfaces of the batteries 40. In the present embodiment, the lower surface of the lower part of the front section is placed above the lower case 23 at a distance from its inner bottom surface. Therefore, the reinforcement frame 32 supports the whole of the batteries 40 of the battery group.

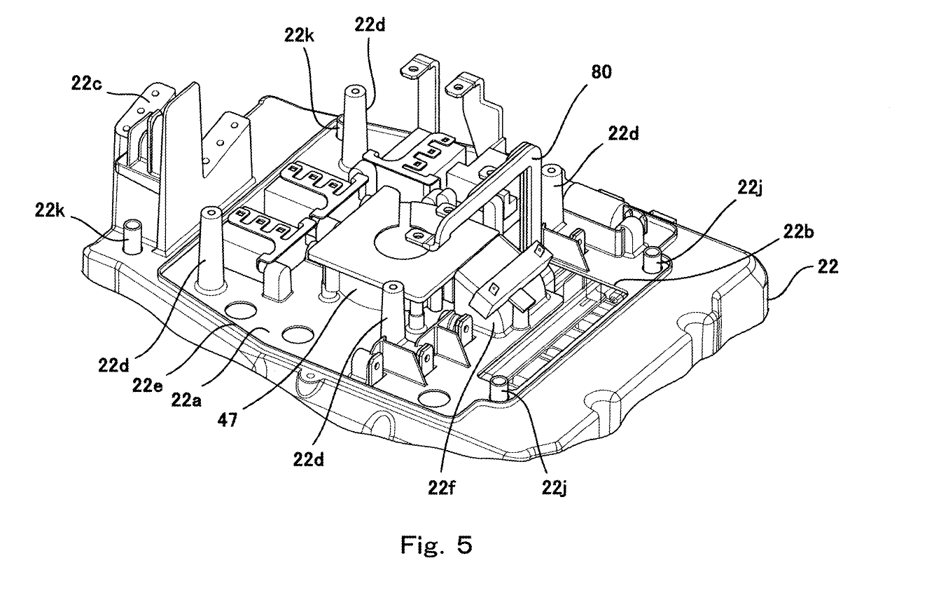

FIG. 5 is a perspective view of a region above the battery case 20 of the electric motorcycle 1 of FIG. 1, when viewed from the right and front, showing a state in which the inverter 47 and the like are detached from the electric component group 46. With reference to FIG. 5 as well as FIGS. 2 and 3, the upper surface of the upper case 22 is formed with an electric component region 22a surrounded by a peripheral rib 22e. The electric component cover 26 is placed over the upper surface of the upper case 22 along the peripheral rib 22e, thereby forming the electric component space S1. The upper case 22 includes a seat section 22c protruding farther upward from the rear side than the electric component region 22a does, in a location that is rearward relative to the electric component region 22a. The charging connector 75 is mounted on the seat section 22c, to charge the batteries 40 with the electric power supplied externally.

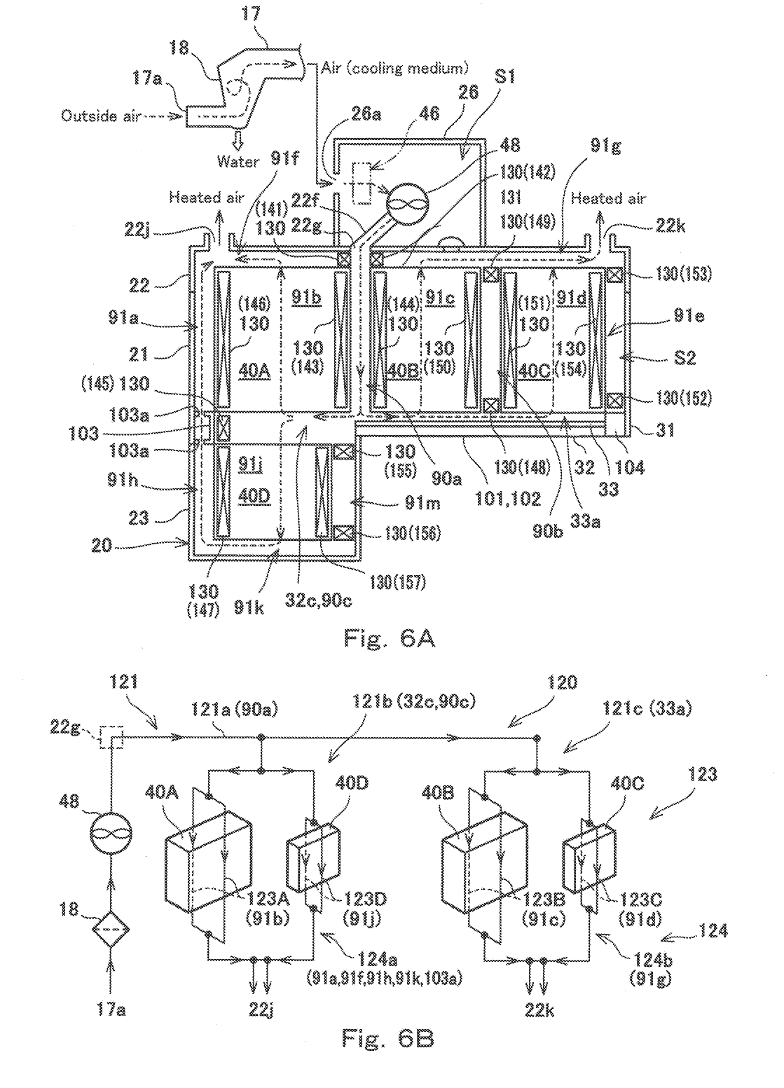

The fan 48 is mounted on the center portion of the electric component region 22a. The fan 48 is placed with a slight gap from the upper surface of the upper case 22. This allows the fan 48 to suction the air upward through the gap formed between the fan 48 and the upper surface of the upper case 22. The upper wall of the upper case 22 is formed with an inlet 22g (see FIG. 6A) via which the electric component space S1 is in communication with the battery space S2. The fan 48 causes the air to flow from the interior of the electric component space S1 into the battery space S2 through the inlet 22g. The upper case 22 is formed with a duct member 22f connecting the discharge outlet of the fan 48 to the inlet 22g. All of the air discharged from the fan 48 is guided to the inlet 22g.

The electric component region 22a is provided with a plurality of support elements 22d surrounding the fan 48. The inverter 47 is mounted on the support elements 22d. The inverter 47 is placed above at a slight distance from the fan 48. Since the fan 48 is a sirocco fan, it may be configured to have a small height, and the inverter 47 is also configured to have a small vertical dimension, and to be flat. For this reason, even when each of the fan 48 and the inverter 47 has a double-wall structure, it becomes possible to suppress an increase in the vertical dimension of the electric component space S1.

The upper surface of the upper case 22 is provided with outlets 22j, 22k through which the air (hereinafter will also be referred to as “heated air”) which has taken heat out of the batteries 40 is discharged from the battery space S2. The outlets 22j, 22k are placed to be spaced apart from each other in the forward and rearward direction. The duct member 22f and the inlet 22g (see FIG. 6A) connected to the duct member 22f are disposed between the front outlet 22j and the rear outlet 22k. Each of the front outlet 22j and the rear outlet 22k include a pair of right and left outlets. In brief, the upper case 22 is provided with four outlets 22j, 22k.

The outlets 22j are provided within the electric component region 22a and each outlet protrudes upward in a cylindrical shape. The front end portion of the electric component cover is provided with a pair of right and left cylindrical portions 26b, 26c, vertically penetrating therethrough. The cylindrical portions 26b, 26c are fitted into the front outlets 22j, respectively. One of the rear outlets 22k is provided within the electric component region 22a and protrudes upward in a cylindrical shape. The rear end portion of the electric component cover is provided with a cylindrical portion 26d to be fitted to this rear outlet 22k. In this structure, the air which has flowed through the outlets 22j, 22k, is discharged outside of the electric motorcycle 1 without flowing through the electric component space S1. Also, positioning is enabled by using the cylindrical portions 26b to 26d and the outlets 22j, 22k. The other of the rear outlets 22k is placed outside of the electric component region 22a. Therefore, the air which has flowed through this rear outlet 22k does not return to the electric component space S1. Since the positioning in three locations is enabled by using the cylindrical portions 26b to 26d and the outlets 22j, 22k, it becomes possible to prevent a situation in which the electric component cover 26 is mounted in a reversed positional relationship in the forward and rearward direction.

FIG. 6A is a left side cross-sectional view of the battery case, schematically showing the flow of air for cooling the batteries in the electric motorcycle 1 of FIG. 1. FIG. 6B is a view showing the flow of air for cooling the batteries in the electric motorcycle 1 of FIG. 1. As shown in FIG. 6A, the outside air flows into the air-intake duct 17 via the inlet 17a, the water is removed by the water removing section 18, and then the air from which the water has been removed, flows into the electric component space S1 through an air inlet 26a. In the interior of electric component space S1, the air is suctioned into the fan 48 and sent with pressure through the discharge outlet of the fan 48. As described above, the discharge outlet is connected to the duct member 22f provided integrally with the upper surface of the upper case 22, and the duct member 22g is in communication with the outlet 22g provided on the upper wall of the upper case 22. The air sent with pressure by the fan 48 flows sequentially through the duct member 22f and the inlet 22g, and into the battery space S2 from above. In the interior of the battery space S2, a cooling passage 120 is provided, through which the air which has flowed through the inlet 22g travels in one direction toward the outlets 22j, 22k. The cooling passage 120 is defined in such a way that the battery space S2 is partitioned by seal members 130. The cooling passage 120 includes a space formed between the plurality of batteries 40, and a space formed between the batteries 40 and the inner surface of the battery case 20. The seal members 130 selectively seal adjacent spaces to form the air flow travelling in one direction as described above.

The space formed between the plurality of batteries 40 includes a space 90a formed between a battery 40A placed at a foremost location and a battery 40B placed behind the battery 40A in the upper part of the front section. In addition, the space formed between the plurality of batteries 40 includes a space 90b formed between the battery 40B and a battery 40C placed at a rearmost location. The space formed between the plurality of batteries 40 includes a space 90c formed between the battery 40A placed at a foremost location and the battery 40D of the lower part of the front section. The space 90c is located within the lower end opening 32c of the middle case 21.

The space formed between the batteries 40 and the inner surface of the battery case 20 includes a space 91a formed between the battery 40A placed at a foremost location and the inner front surface of the middle case 21. The space formed between the batteries 40 and the inner surface of the battery case 20 also includes a pair of spaces 91b formed between the battery 40A placed at a foremost location and the inner side surface of the middle case 21, a pair of spaces 91c formed between the battery 40B located at the center of the upper section and the inner side surface of the middle case 21, a pair of spaces 91d formed between the battery 40C placed at a rearmost location and the inner side surface of the middle case 21, and a space 91e formed between the battery 40C placed at a rearmost location and the inner rear surface of the middle case 21. The space formed between the batteries 40 and the inner surface of the battery case 20 further includes spaces 91f, 91g formed between the upper surfaces of the batteries 40A to 40C of the upper section and the inner upper surface of the upper case 22, a space 91h formed between the battery 40D of the lower section and the inner front surface of the lower case 23, a space 91j formed between the battery 40D of the lower section and the inner side surface of the lower case 23, a space 91k formed between the battery 40D of the lower section and the inner bottom surface of the lower case 23, and a space 91m formed between the battery 40D of the lower section and the inner rear surface of the lower case 23. The recess 33a of the bottom plate 33 is covered by the lower surfaces of the batteries 40B, 40C of the upper section. Since the lower surface of the bottom plate 33 also constitutes the lower surface of the rear portion of the battery case 20, the recess 33a of the bottom plate 33 also serves as the space formed between the batteries 40 and the battery case 20.

As shown in FIG. 6B, the cooling passage 120 includes an upstream space 121, an intermediate space 123, and a downstream space 124. The upstream space 121 is a part of the space, and the cooling medium (air) which has not yet taken heat out of the batteries 40 flows into the upstream space 121 through the inlet 22g. The intermediate space 123 is a part of the space, and is continuous with the upstream space 121. The air takes heat out of the batteries 40 while flowing through the intermediate space 123. The downstream space 124 is a part of the space, and is continuous with the intermediate space 123. The downstream space 124 guides the cooling medium (air) which has taken heat out of the batteries 40 to the outlets 22J, 22k.

As shown in FIG. 6A, the inlet 22g provided on the upper wall of the upper case 22 is opened in a space formed between the inner upper surface of the upper case 22 and the upper surface of the battery group, while the space 90a is located below the inlet 22g. The air flows into the space 90a through the inlet 22g, and travels downward in the interior of the space 90a. The lower end of the space 90a is in communication with the recess 33a extending rearward from the lower end, and with the lower end opening 32c extending forward from the lower end. The space 90c is located in the lower end opening 32c. In this structure, a portion of the air which has flowed through the space 90a flows forward toward the lower end opening 32c (space 90a), while a portion of the air flows rearward toward the recess 33a.

A portion of the air within the lower end opening 32c flows into the pair of right and left spaces 91b, and flows upward along the left side surface and right side surface of the battery 40A. In this process, the air can take heat out of the battery 40A. The upper end portions of the pair of right and left spaces 91b are opened in the space 91f, and the air which has flowed through the right space 91b and the air which has flowed through the left space 91b join together in the space 91f. The outlets 22j are provided on the upper surface of the upper case 22 and opened in the space 91f. The air is discharged from the space 91f to outside of the battery case 20 through the outlets 22j.

A portion of the air within the lower end opening 32c also flows into the pair of right and left spaces 91j, and flows downward along the left side surface and right side surface of the battery 40D. In this process, the air can take heat out of the battery 40D. The lower end portions of the pair of right and left spaces 91j are opened in the space 91k, and the air which has flowed through the right and left spaces 91b flows into the space 91k. The space 91k is in communication with the space 91h. The space 91h is in communication with the space 91a, through a through-hole 103a provided in the front member 103 of the reinforcement frame 32 to vertically penetrate therethrough. The upper end of the space 91a is in communication with the space 91f. The air which has taken heat out of the battery 40D flows into the space 91f through the space 91k, the space 91h, the through-hole 103a and the space 91a and is discharged from the space 91f to outside of the battery case 20 through the outlets 22j, as in the above-described manner.

A portion of the air within the recess 33a flows into the pair of right and left spaces 91c, and flows upward along the left side surface and right side surface of the battery 40B. In this process, the air can take heat out of the battery 40B. The upper end portions of the pair of spaces 91c are opened in the space 91g, and the air which has flowed through the right space 91c and the air which has flowed through the left space 91c join together in the space 91g. The outlets 22k are provided on the upper surface of the upper case 22 and opened in the space 91g. The air is discharged from the space 91g to outside of the battery case 20 through the outlets 22k.

A portion of the air within the recess 33a also flows into the pair of right and left spaces 91d, and flows upward along the left side surface and right side surface of the battery 40C. In this process, the air can take heat out of the battery 40C. The upper end portions of the pair of right and left spaces 91d are opened in the space 91g. The air which has flowed through the right space 91d and the air which has flowed through the left space 91d join together in the space 91g, and is discharged from the space 91g to outside of the battery case 20 through the outlets 22k, as in the above-described manner.

As shown in FIG. 6B, the upstream space 121 includes the space 90a, the lower end opening 32c (space 90c), and the recess 33a. The space 90a constitutes a common upstream space 121a common to the four batteries 40A to 40D. The lower end opening 32c (space 90c), and the recess 33a constitute branch upstream spaces 121b, 121c connected in parallel with the common upstream space 121a, respectively. The first branch upstream space 121b serves to guide the air from the common upstream space 121a to flow to cool the batteries 40A, 40D with the lower end opening 32c interposed between them in the vertical dimension. The second branch upstream space 121c serves to guide the air from the common upstream space 121a to flow to cool the batteries 40B, 40C placed above the recess 33a.

An intermediate space 123 corresponds to the batteries 40A to 40D in a one-to-one correspondence. The battery 40A corresponds to the pair of spaces 91b as an intermediate space 123A. The battery 40B corresponds to the pair of spaces 91c as an intermediate space 123B. The battery 40C corresponds to the pair of spaces 91d as an intermediate space 123C. The battery 40D corresponds to the pair of right and left spaces 91j as an intermediate space 123D.

A downstream space 124 includes a first downstream space 124a corresponding to the intermediate spaces 123A, 123D, and a second downstream space 124b corresponding to the intermediate spaces 123B, 123C. The first downstream space 124a includes the spaces 91a, 91f, 91h, 91k, and the through-hole 103a. The second downstream space 124b includes the space 91g.

The intermediate spaces 123A, 123D are connected in parallel with the first branch upstream space 121b and with the first downstream space 124a. The intermediate spaces 123B, 123C are connected in parallel with the second branch upstream space 121b and with the second downstream space 124b. The four intermediate spaces 123A to 123D are connected in parallel with the inlet 22g, the air inlet 26a or the inlet 17a, and are connected in parallel with the outside air via the outlets 22j, 22k. In this structure, it becomes possible to prevent a situation in which after the air which has flowed into the battery space S2 through the inlet 22g takes heat out of one of the batteries 40, it passes through a space between the other batteries 40. In other words, all of the batteries 40 can exchange heat with the air directly guided thereto through the inlet 22g. As a result, all of the batteries 40 can be suitably cooled.

In the present embodiment, the first downstream space 124a includes a first downstream space vertically extending continuously from the intermediate space 123D, and a second downstream space connecting the first downstream space to the outlet 22j and extending horizontally. The first downstream space includes the spaces 91a, 91k, 91h, and the through-hole 103a. The second downstream space includes the space 91f. The air with a high temperature tends to collect in an upper region due to convection. An air flow can be formed by utilizing convection, which is an advantage. In this way, cooling performance can be ensured even when the amount of air flow is small.

The cooling passage will be discussed in other words. The inlet 22g is provided on the upper portion of the battery case 20. The cooling passage 120 includes a lower space which is placed below at least one of the batteries (in the present embodiment, the batteries 40A to 40C) and into which the cooling medium from the inlet 22g which has not yet sufficiently taken heat out of the batteries 40A to 40D flows. This lower space includes the space 90c and the recess 33a. In the above description, this lower space corresponds to the first branch upstream space 121a and the second branch upstream space 121b. The outlets 22j, 22k are provided on the upper portion of the battery case 20. The cooling passage 120 includes a vertical space located adjacently to the batteries 40 and extending vertically, and a horizontal space connecting the vertical space to the outlets and extending horizontally. The vertical space may include the spaces 91b, 91c, 91d, while the horizontal space may include the spaces 91f, 91g. In other words, the vertical space may correspond to the intermediate spaces 123A to 123C in the above description, while the horizontal space may correspond to the first downstream space 124a and the second downstream space 124b in the above description. The vertical space may include the spaces 91h, 91a and the through-hole 103a, while the horizontal space may include the space 91f. In other words, the vertical space may correspond to the first downstream space of the first downstream space 124a in the above description, while the horizontal space may correspond to the second downstream space of the first downstream space 124a in the above description.

In order to form the above-described air flow, in the present embodiment, the seal members 130 are provided in specified locations 141 to 157 in the spaces, respectively. The seal members 130 serve to partially narrow or close the spaces, to inhibit air communication between the spaces. The seal members 130 may be made of an elastic material such as rubber or urethane. Before the battery group is formed, the seal members 130 are preliminarily bonded to the batteries 40. Or, before the plurality of batteries 40 are integrated by the casing 41 and accommodated into the battery case 20, the seal members 130 are preliminarily bonded to the battery group. The plurality of batteries 40 provided with the seal members 130 are integrated by the casing 41, and thereby the seal members 130 are crushed by the batteries 40 with each of the seal members 130 interposed between the batteries 40. This makes it possible to ensure the sealing performance in each space which is formed between the batteries 40. Since the battery group provided with the seal members 130 is accommodated into the battery case 20 as described above, the seal members 130 are crushed by the inner surfaces of the battery case 20, and as a result, the seal performance can be ensured in each space which is formed between the batteries 40 and the battery case 20.

The seal members 130 are placed in the locations 141 to 145 to inhibit the air from directly flowing from the upstream space 121 to the downstream space 124 without flowing through the intermediate space 123. In this structure, it becomes possible to prevent a situation in which the air which has flowed into the upstream space 121 through the inlet 22g directly flows into the downstream space 124 without taking heat out of the batteries 40. In addition, it becomes possible to prevent a situation in which the air which has taken heat out of the batteries 40 is circulated in the interior of the battery space S2.

For example, the seal members 130 are provided in the location 141 (upper surface rear end portion of the battery 40A) where the space 90a (common upstream space 121a) is adjacent to the space 91f (first downstream space 124a), and the location 142 (upper surface front end portion of the battery 40B) where the space 90a (common upstream space 121a) is adjacent to the space 91g (second downstream space 124b), respectively. In addition, the seal members 130 are provided in the location 143 (side surface rear end portion of the battery 40A) where the space 90a (common upstream space 121a) is adjacent to the space 91b (intermediate space 123A), and the location 144 (side surface front end portion of the battery 40B) where the space 90a (common upstream space 121a) is adjacent to the space 91c (intermediate space 123B), respectively. In addition, the seal member 130 is provided in the location 145 (inner edge portion of the front member 103) where the space 90c (first branch upstream space 121b) is adjacent to the spaces 91a, 91h (first downstream space 124a).

The seal members 130 are selectively provided in the locations 146, 147 where the intermediate space 123 is adjacent to the first downstream space. This makes it possible to prevent a situation in which the air being taking heat out of the batteries 40 undesirably flows to the first downstream space.

For example, the seal members 130 are provided in the location 146 (side surface front end portion of the battery 40A) where the space 91b (intermediate space 123A) is adjacent to the space 91a (first downstream space of the first downstream space 124a), and the location 147 (side surface front end portion of the battery 40D) where the space 91j (intermediate space 123D) is adjacent to the space 91h (first downstream space of the first downstream space 124a), respectively.

A part of the spaces (spaces 90b, 91e, 91m) may not be utilized as the cooling passage. In particular, the spaces 90b, 91e, 91m which extend vertically in parallel with the intermediate space 123 and allow communication between the upstream space 121 and the downstream space 124 by bypassing the intermediate space 123 may not be utilized as the cooling passage. In this structure, the air flowing from the upstream space 121 flows into the intermediate space 123 without fail. In addition, the air which has taken heat out of the batteries 40 do not return to the upstream space 121, and as a result, the batteries 40 can be cooled more efficiently. In light of this, in the present embodiment, to inhibit the air from flowing into the spaces 90b, 91e, 91m, the seal members 130 are selectively provided within the spaces 90b, 91e, 91m, or in the locations 148 to 157, in the vicinity of the spaces 90b, 91e, 91m.

For example, the space 90b is sandwiched between the two intermediate spaces 123B, 123C and extends in parallel with the intermediate spaces 123B, 123C. The seal members 130 are provided in the location 148 (lower end portion of the space 90b) where the space 90b is adjacent to the recess 33a (second branch upstream space 121c), the location 149 (upper end portion of the space 90b) where the space 90b is adjacent to the space 91g (second downstream space 124b), the location 150 (side surface rear end portion of the battery 40B) where the space 90b is adjacent to the space 91c (intermediate space 123B), and the location 151 (side surface front end portion of the battery 40C) where the space 90b is adjacent to the space 91d (intermediate space 123C), respectively.

For example, the space 91e is placed rearward relative to the intermediate space 123C and extends in parallel with the intermediate space 123C. The seal members 130 are placed in the location 152 (lower end portion of the space 91e) where the space 91e is adjacent to the recess 33a (second branch upstream space 121c), the location 153 (upper end portion of the space 91e) where the space 91e is adjacent to the space 91g (second downstream space 124b), and the location 154 (side surface rear end portion of the battery 40C) where the space 91e is adjacent to the space 91d (intermediate space 123C), respectively.

For example, the space 91m is placed rearward relative to the first downstream space 123D and extends in parallel with the first downstream space 123D. The seal members 130 are placed in the location 155 (upper end portion of the space 91m) where the space 91m is adjacent to the space 90c (first branch upstream space 121b), the location 156 (lower end portion of the space 91m) where the space 91m is adjacent to the space 91k (first downstream space 124a), and the location 157 (side surface rear end portion of the battery 40D) where the space 91m is adjacent to the space 91j (intermediate space 123D), respectively.

Since the seal members 130 are placed in the above-described manner, the above-described air flow is formed, and heat can be sufficiently taken out of all of the batteries 40 while preventing convection of the air. In addition, the air which has taken heat out of the batteries 40 can be discharged well outside of the battery case 20. Thus, the cooling efficiency of the batteries 40 can be increased and the temperature non-uniformity of the batteries 40 can be suppressed.

The layout of the seal members 130 will be described from another perspective. In the present embodiment, in the intermediate spaces 123, the air traveling vertically takes heat out of the batteries 40. To guide the air from the inlet 22g to the entrances of the intermediate spaces 123 (the lower end portion of the space 91b, the lower end portion of the space 91c, the lower end portion of the space 91d, and the upper end portion of the space 91j), the seal members 130 are placed in the locations 141 to 147 where air leakage to other passages (the intermediate spaces other than those corresponding to the entrances and the downstream spaces 124) can be prevented. To guide the air from the inlet 22g to the entrances of the intermediate spaces 123, the seal members 130 are placed in the locations 149, 151, 152, 153, 155, 157 where air leakage to the spaces which are not expected to serve as the passages can be prevented.

To guide the air to the exits of the intermediate spaces 123 (the upper end portion of the space 91b, the upper end portion of the space 91c, the upper end portion of the space 91d, and the lower end portion of the space 91j), the seal members 130 are placed in the locations 141, 142 where air leakage to another passages (the intermediate spaces other than those corresponding to the exits and the upstream spaces 121) can be prevented. To guide the air from the exits of the intermediate spaces 123 to the outlets 22j, 22k, the seal members 130 are placed in the locations 150, 154, 158 where air leakage to the spaces which are not expected to serve as the passages can be prevented.

Since the seal members 130 are placed in the above-described manner, the above-described air flow is formed. Therefore, the cooling efficiency of the batteries 40 can be increased and the temperature non-uniformity of the batteries can be suppressed.

In the present embodiment, in the upstream spaces 121, the branch points (points at which the common upstream space 121a branches (is divided) into the two branch upstream spaces 121b, 121c) set for each of the batteries 40A to 40D, at which the common upstream space 121a branches into the entrances of the intermediate spaces 123A to 123D, are set in the inner region of the battery case 20. In particular, in the present embodiment, the branch points are placed in the center of the battery space S2 in the forward and rearward direction and in the vertical direction. This can lessen the non-uniformity of the amount of the air to be supplied to the intermediate spaces 123A to 123D. Alternatively, the passage resistances in the upstream spaces 121 may be suitably changed to equalize the air flow. For example, the passage resistance in the recess 33a may be suitably changed to supply the air with a sufficient amount to the entrance of the intermediate space 123C located to be most distant from the branch point.

The air which has taken heat out of the batteries tends to collect in the upper region, due to convection. The outlets 22j, 22k are provided on the upper wall of the upper case 22. Because of this, the air can be easily discharged and the above-described air flow can be easily formed. As a result, it becomes possible to prevent heat from being accumulated in the interior of the battery case 20.

The inlet 22g, the outlets 22j, and the outlets 22k are provided on the same wall (in the present embodiment, upper wall of the upper case 22) of the battery case 20 such that the inlet 22g, the outlets 22j, and the outlets 22k are apart from each other. Therefore, the seal members 130 which define the upstream spaces 121 and the downstream spaces 124 extend in the direction (in the present embodiment, vehicle width direction) crossing straight lines (in the present embodiment, straight lines extending substantially in the forward and rearward direction) connecting the inlet 22g to the outlets 22j, 22k, and are placed between the inner surface of the wall (in the present embodiment, upper wall of the upper case 22) on which the inlet 22g, and the outlets 22j, 22k are provided, and the obverse surface (in the present embodiment, upper surface) of the battery group.

The inlet 22g is provided on the upper wall of the upper case 22. The duct member 22f serves to guide the air from the fan 48 to the inlet 22g in such a way that the air flows downward in the vicinity of the inlet 22g. The space 90a is placed in parallel with the direction in which the air flows from the inlet 22g into the upper case 22. This allows the air which has passed through the inlet 22g to be sent smoothly to the space 90a. Also, the air flows downward smoothly in the interior of the space 90a.

The fan 48 is placed outside of the battery case 20. For this reason, the battery space S2 is not occupied by the fan 48. Maintenance for the fan 48 can be carried out without a need to open and close the battery case 20.

In the present embodiment, the duct member 22f is attached on the battery case 20 to guide the air from outside of the battery case 20 to the inlet 22g. Since the inlet 22g is provided on the upper portion of the battery case 20, the duct member 22f protrudes outward and upward from the battery case 20.

If the inlet 22g is provided on the lower portion of the battery case 20, the duct member 22f protrudes outward and downward from the battery case 20. In the present embodiment, since such a projection projecting downward is not provided on the battery case 20, the vehicle body can be inclined to a large degree without interference with a road surface during a turn of the electric motorcycle 1. Since the inlet 22g and the duct member 22f are placed at a distance from the road surface not to face the road surface, it also becomes possible to prevent the outside air heated by the road surface from being taken into the battery space S2.

If the inlet 22g is provided on the side portion of the battery case 20, the duct member 22f protrudes outward in the vehicle width direction from the battery case 20. In the present embodiment, since such a projection projecting laterally is not provided on the battery case 20, the dimension of the vehicle body in the vehicle width direction is not increased. Therefore, this configuration is suitable for a straddle-type electric vehicle which is limited in the vehicle width dimension. Moreover, it becomes possible to prevent interference between the components such as the vehicle body frame 10 and the battery case 20.

Since the duct member 22f and the outlets 22f are provided on the upper portion of the battery case 20, the battery case 20 can be placed as close to the road surface as possible, and the center of gravity of the vehicle body can be lowered. Since the outlets 22j, 22k are provided on the battery case 20, the duct section (in the present embodiment, the outlets 22j, 22k protruding in the cylindrical shape and the cylindrical portions 26b to 26d of the electric component cover 26) protruding to guide the air outside of the battery case 20 can achieve the same advantages as those of the duct member 22f.

In the interior of the battery space S2, the cooling passage extending from the inlet 22g provided on the upper wall of the upper case 22 to the outlets 22j, 22k provided on the upper wall of the upper case 22 has a U-shape in which the cooling passage is turned back. This can increase the length of the cooling passage in the interior of the battery case 20, and hence the cooling efficiency.

In the present embodiment, the downstream space includes the space 91k (i.e., space which is close to the bottom portion of the battery case 20) on the lower end of the battery 40D located at the lowermost side in the battery group. In contrast, the inlet 22g is provided on the upper portion of the battery case 20. In this structure, the air can be guided from the upper portion of the battery case 20 to the space which is close to the bottom portion of the battery case 20. This makes it possible to prevent a situation in which the air is discharged outside of the battery case 20 before it reaches the battery 40D located at the lowermost side.

For the batteries 40A to 40C located at the upper side, the air which has not yet sufficiently taken heat out of the batteries flows from the lower ends thereof to the upper ends thereof. Since the air flows as in convection due to a temperature increase, heat accumulation is easily prevented. For the battery 40D located at the lower side, the air which has not yet sufficiently taken heat out of the batteries flows from the upper end thereof to the lower end thereof. Since thereafter the air which has taken heat flows as in convection due to a temperature increase, heat accumulation is easily prevented. Specifically, the downstream space 124a extending to the upper portion of the battery case 20 is continuous with the lower portion of the battery 40D located at the lower side. The downstream space 124a has an entrance at the lower end of the battery 40D, and an exit at the upper end of the battery 40D. Since the seal member 130 is provided to inhibit the air from joining the air flow in a region other than the lower end of the battery 40D located at the lower side, the air within the downstream space 124a flows as in convection, with an increase in the temperature of the air.

Since the air (ram air) flowing from the front is introduced into the battery case 20, the air is introduced more easily than other air is. Therefore, even when the fan 48 is operated by low driving power during driving or stopped in the middle of driving, the batteries 40 can be cooled.

The upstream spaces 121 serve to guide the air to the lower ends of the three batteries 40A to 40C of the four batteries 40. The air flows upward in the three intermediate spaces 123A to 123C corresponding to the batteries 40A to 40C, respectively. Due to convection, the air with a low temperature tends to collect in a lower region, and the air with a high temperature tends to collect in an upper region. Since heat exchange takes place along the air flow formed by utilizing convection, the above-described air flow is easily formed, and heat accumulation in the interior of the battery case 20 can be prevented.

The outlets 22j, 22k are placed such that the inlet 22g is interposed between the outlets 22j, 22k in the forward and rearward direction. In this structure, the air flows into a center region in the forward and rearward direction, then the air flow is divided into a front side and a rear side, and thereafter the air can be discharged through the front and rear outlets without flowing laterally across the upstream space. For this reason, the layout and structure of the seal member 130 do not become complex. The front outlet 22j includes the pair of right and left outlets. This allows the air which has flowed through the pair of right and left spaces 91b, 91j (intermediate spaces 123A, 123D) to be discharged smoothly outside of the battery case 20 through the right and left front outlets 22j. Therefore, it is possible to suppress the air which has taken heat out of the battery from becoming stagnant in the first downstream space 124a. The rear outlets 22k and the pair of right and left spaces 91c, 91d have the same relationship.

The fan 48 is located immediately above the space 90a. The inlet 22g is located to vertically overlap with the space 90a. In contrast, the lower end portion of the space 90a is close to the battery of the front lower section of the battery group. In this structure, the air introduced into the battery case 20 from above is easily supplied to the battery located in the lower section. Since the sirocco fan is used as the fan 48, the air flow to the outlets 22j, 22k can be formed even if an air flow resistance in the cooling passage 120 is relatively high.

The air inlet 26a is placed above the battery case 20 at a distance from the upper surface of the battery case 20. Because of this, even when water droplets adhere to the upper surface of the battery case 20, the water droplets are less likely to enter the battery case 20.

As described above, the electric wires and the like are provided to penetrate the battery case 20 between the electric component space S1 and the battery space S2. Therefore, the openings are formed in the electric component region 22a on the upper surface of the battery case 22. The openings are sealed closed with fluid tightness and air tightness, by sealing members 131 (see FIG. 6) such as grommets. This makes it possible to prevent the air from leaking to the electric component space S1 and foreign matters in the electric component space S1 from entering the battery space S2.

The present invention is not limited to the above-described embodiment. The above-described configuration may be changed, added to, or deleted from, within a scope of the spirit of the present invention. For example, the battery case or the electric component cover may be provided with a drain hole which is openable and closable. Depending on the location in the forward and rearward direction at which the battery of the lower section is placed, the mounting location of the fan can be suitably changed. In a case where the ram air is used as the cooling medium like the present embodiment, a filtering method in which an air filter is placed in the air-intake duct 17 or a labyrinth method in which a water cut plate is placed in the air-intake duct 17 may be used as the water removing section, in addition to or instead of the centrifugal method of the above embodiment. The fan 48 may be omitted, and the air may be supplied to the interior of the battery case 20, by ram pressure. In addition to or instead of the fan 48, another fan may be attached on the outlet. The fan 48 may be placed downstream of the outlets 22j, 22k. Or, the fan 48 may be accommodated into the battery case 20 such that the fan 48 is placed between the inlet 22g and the outlets 22j, 22k. Although the plurality of outlets and the single inlet are provided in the above example, a single outlet may be provided, or a plurality of inlets may be provided. The seal member 130 may not completely seal the space and may be placed to narrow a passage cross-sectional area.

Although in the above embodiment, the battery group includes the four batteries A to D, and the intermediate spaces 123 are formed by the spaces formed between the side surfaces of the batteries and the inner side surfaces of the battery case, this configuration can be suitably changed. For example, the batteries A to D may be configured such that a plurality of battery packs are accommodated into a casing of a frame shape. In this case, the plurality of battery packs are aligned with slight gaps in the interior of the casing of a frame shape, and the gaps may be exposed to outside of the batteries. In this case, the intermediate spaces 123 may include spaces formed between the battery packs in the interior of the batteries 40A to 40D, in addition to or instead of the spaces formed between the side surfaces of the batteries and the inner side surfaces of the battery case. The alignment of the batteries is not particularly limited. For example, the plurality of battery packs may be aligned in one line in the lengthwise direction of the casing of a frame shape.

In this case, the seal members are placed to inhibit the air flowing from the inlet from travelling to a region other than the space formed between the battery packs. Also, the seal members 130 are placed to permit the air flow only from the entrance between the battery packs to the exit. In this structure, a difference in temperature gradient between the battery packs of each of the batteries 40A to 40D of the above embodiment can be lessened, so that the performance of the batteries 40A to 40D can be maintained more easily. In this case, also, the seal members 130 are preferably placed to close the spaces which are not used as the upstream spaces 121, the intermediate spaces 123 and the downstream spaces 124.

In another example, the seal members may be placed to close the spaces formed between the batteries 40 and the battery case 20, or between the batteries so that the air flowing through the space between the battery packs takes heat out of the batteries 40. In this case, the seal members are placed to close the spaces extending vertically between the batteries or the spaces formed between the batteries and the battery case 20, which are other than the upstream spaces and the downstream spaces.

Although in the above embodiment, the electric motorcycle is exemplarily described as the electric vehicle, the present invention is applicable in the same manner to other electric vehicles including a battery case accommodating a plurality of batteries, such as an electric three-wheeled vehicle or an electric four-wheeled vehicle.

The seal members 130 may be formed by a portion of the batteries 40 and the battery case 20. This can reduce the number of members as compared to a case where dedicated members are used. In addition, by positioning the batteries 40, a seal function can be attained and an operation can be performed easily. The seal members need not completely seal the spaces with fluid tightness and air tightness, so long as the air flow resistance can be increased to inhibit the air flow.

Although in the above embodiment, the ram air introduced into the air-intake duct 17 including the inlet 17a at the front end thereof is utilized as the cooling medium for cooling the batteries 40, air other than the ram air may be taken in and used as the cooling medium. For example, the inlet 17a need not be opened toward the front. If the inlet 17a is oriented downward or laterally, it is less likely that the water contained in the ram air enters the battery case 20.

Although in the above embodiment, the cooling system for cooling the batteries employs a method (open-cooling system) in which the outside air is taken in as the cooling medium and heated air is discharged to the outside, the outside air need not be always utilized as the cooling medium. The cooling medium may be circulated through a closed space or passage. For example, a pipe connecting the outlet to the inlet may be provided and the air may be cooled while flowing through the pipe. Thereby, the water is less likely to enter the battery case 20, as compared to the case where the outside air is used. In the case of such a closed cooling method, the cooling medium need not be the air and may be liquid. Also, the fan may be omitted so long as the air travels in one direction in the interior of the battery case 20.

### INDUSTRIAL APPLICABILITY

As described above, the electric vehicle of the present invention can obtain a clear advantage that the cooling performance of the plurality of batteries accommodated in the battery case can be improved with a simple configuration, which is effectively applicable to the electric vehicle such as the electric motorcycle which can exhibit this advantage.

### REFERENCE CHARACTER LIST

1 electric motorcycle
2 front wheel
3 rear wheel
18 water removing section
20 battery case
22g inlet
22j, 22k outlet
40 battery
42 electric motor
48 fan
90a to 90d, 91a to 91m space
120 flow passage
121 (121a to 121c) upstream space
122A to 122D cooling passage
123 (123a, 123b) downstream space
130 seal member
S2 battery space

1. An electric vehicle comprising:
an electric motor for generating a driving power for driving a wheel; and
a battery case accommodating a plurality of batteries storing DC power to be supplied to the electric motor, in an inner battery space;
wherein the plurality of batteries are arranged in an interior of the battery case,
wherein the battery case includes an inlet through which a cooling medium is introduced into the battery space, and an outlet through which the cooling medium which has cooled the plurality of batteries is discharged outside of the battery space, and
wherein a seal member is placed in a predetermined location of a space formed between the plurality of batteries or between the batteries and the battery case, the seal member defining a cooling passage in which the cooling medium introduced through the inlet travels in one direction through the space toward the outlet.

2. The electric vehicle according to claim 1,
wherein the cooling passage includes:
an upstream space which is constituted by a portion of the space and into which the cooling medium from the inlet which has not yet taken heat out of the batteries flows into;
an intermediate space which is constituted by a portion of the space, which extends continuously from the upstream space, and in which the cooling medium takes heat out of the batteries; and
a downstream space which is constituted by a portion of the space, extends continuously from the intermediate space, and guides the cooling medium which has taken heat out of the batteries to the outlet,
wherein the seal member is placed in a location to inhibit the cooling medium from directly flowing from the upstream space to the downstream space without flowing through the intermediate space.

3. The electric vehicle according to claim 1,
wherein the inlet is provided on an upper portion of the battery case, and
wherein the cooling passage includes a lower space which is placed below at least one of the batteries and into which the cooling medium from the inlet flows.

4. The electric vehicle according to claim 1,
wherein the outlet is provided on an upper portion of the battery case, and
wherein the cooling passage includes a vertical space which is adjacent to the batteries and extends vertically, and a horizontal space connecting the vertical space to the outlet and extending horizontally.

5. The electric vehicle according to claim 1,
wherein the outlet is provided on an upper portion of the battery case.

6. The electric vehicle according to claim 1, comprising:
a water removing section which removes water from air outside of a vehicle body; and
a fan which guides the air from which the water has been removed by the water removing section to the battery space as the cooling medium.

7. The electric vehicle according to claim 2,
wherein a flow direction of the cooling medium in the intermediate space is parallel to a flow direction of the cooling medium in at least one of the upstream space and the downstream space,
wherein the intermediate space is adjacent to at least one of the upstream space and the downstream space, with the seal member interposed between the intermediate space and the at least one of the upstream space and the downstream space, and
wherein the seal member is placed to inhibit the cooling medium from flowing laterally across the flow direction.

8. The electric vehicle according to claim 7,
wherein the at least one of the upstream space and the downstream space includes the upstream space, and
wherein the seal member is placed to inhibit the cooling medium from flowing from the upstream space into the intermediate space before the cooling medium flows into an entrance of the intermediate space.

9. The electric vehicle according to claim 7,
wherein the at least one of the upstream space and the downstream space includes the downstream space, and
wherein the seal member is placed to inhibit the cooling medium from flowing from the upstream space into the downstream space before the cooling medium flows out through an exit of the intermediate space.

10. The electric vehicle according to claim 1,
wherein the outlet is one of a plurality of outlets.

11. The electric vehicle according to claim 10,
wherein the plurality of outlets include two outlets provided to be apart from each other in a forward and rearward direction, and
wherein the inlet is placed between the two outlets in the forward and rearward direction.
